(19) United States
(12) Patent Application Publication
(10) Pub. No.: US 2006/0044637 A1
(43) Pub. Date: Mar. 2, 2006

(54) Hologram changing system

(75) Inventors: Herbert E. Mayer, Triesen (LI); Francis Stace Murray Clube, Neuchatel (CH); Ali Reza Nobari, Marin (CH)

Correspondence Address: Holtronic Technologies Plc., Champs-Montants 12b, Marin, CH-2074, CH

(73) Assignee: Holtronic Technologies Plc.

(21) Appl. No.: 11/217,189

(22) Filed: Sep. 1, 2005

(30) Foreign Application Priority Data
Aug. 25, 2004 (GB) 0418952.8

(51) Int. Cl. G03H 1/20

(52) U.S. Cl. 359/12; 359/35

(57) ABSTRACT

A method and apparatus for automatically printing a pattern of features from a plurality of hologram masks on a lithographic machine, which method includes arranging the plurality of hologram masks on first faces of a plurality of prisms such that the pattern of features recorded in each hologram mask can be printed by an exposure beam illuminating second faces of the plurality of prisms; providing an exposure position at which any of the prisms and hologram masks can be arranged such that the patterns recorded in the hologram mask can be printed; providing a prism storage and transport system in which the prisms and hologram masks not at the exposure position can be arranged and for transporting the prisms and hologram masks between any of the exposure position and prism storage positions; and providing a control system for the prism transport and storage system.

The present invention relates to the field of total internal reflection (TIR) holography, and particular it relates to TIR holography employed for photolithography.

The prior art teaches that an important application of TIR holography is for printing high-resolution microcircuit patterns, especially those needed on glass substrates for certain flat panel display technologies. According to the method, a hologram mask is recorded from a conventional chrome mask containing a pattern of features by firstly placing the mask in close proximity to a holographic recording layer on a glass plate which is in contact with the surface of a glass prism with a layer of transparent fluid between the two. The mask is then illuminated with an object laser beam whilst simultaneously illuminating the holographic recording layer with a mutually coherent reference laser beam through the prism at such an angle that the reference beam is totally internally reflected from the surface of the holographic layer. The optical interference between the light transmitted by the mask and the reference beam is recorded by the photosensitive material in the holographic recording layer, which is subsequently fixed by an appropriate processing step, to form the hologram of the mask pattern. The mask pattern can afterwards be regenerated, or reconstructed, from the hologram mask by re-contacting the hologram mask to a glass prism, again with a layer of fluid between the two, and illuminating the hologram through the prism with a laser beam of the same wavelength as that of the laser beam for recording the hologram and such that the angle of the beam corresponds to the reverse direction of the reference beam during recording. Arranging a substrate, such as a silicon wafer or a glass plate, coated with a layer of photoresist at the same distance from the hologram as the chrome mask was during recording results in the reconstructed pattern being printed onto the substrate surface.

Because of the close proximity between the holographic layer and mask during recording and between the hologram and substrate during reconstruction, the TIR holography method has a very high numerical aperture (˜1) which, in comparison with traditional photolithographic methods, enables a relatively high resolution features to be imaged using a given exposure wavelength, for example, 0.4 micron features may be routinely printed with an exposure wavelength of 364 nm. Further, in contrast to traditional exposure methods, with TIR holographic lithography there is no trade-off between feature resolution and pattern size thus allowing, for example, a pattern with 0.4 micron features to have dimensions 150 mm×150 mm.

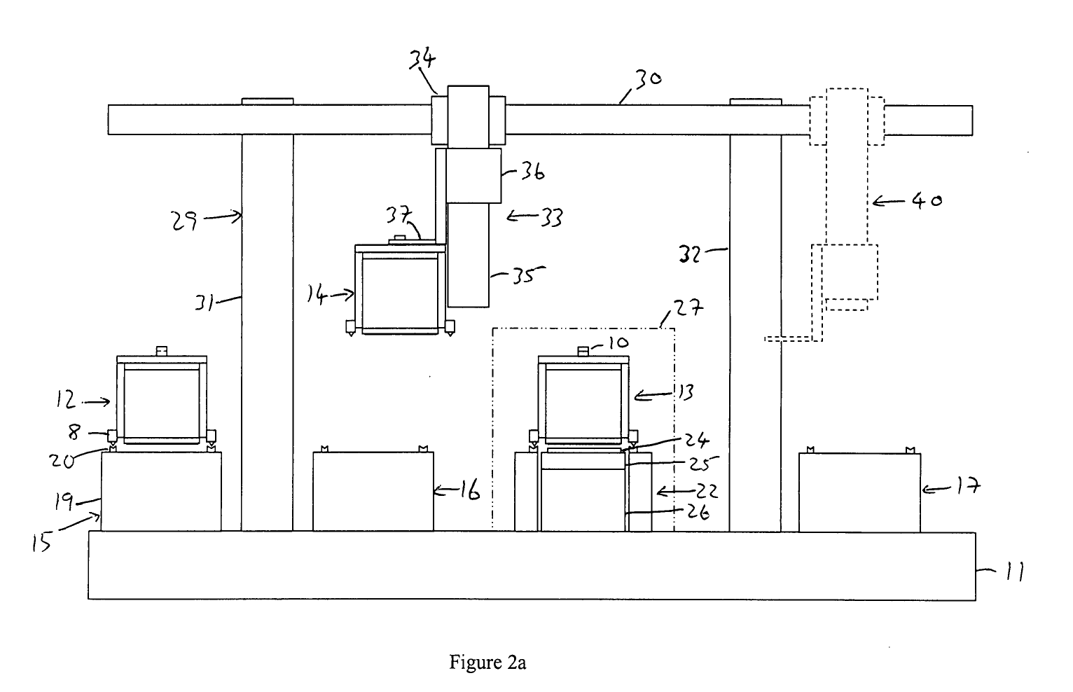

Lithographic exposure equipment based on this technique has been developed and commercialised. FIG. 2 shows a schematic diagram of such a machine. At the centre of the system is the hologram mask mounted to the bottom face of a 45°, 45°, 9020 prism with a layer of transparent fluid between the two. This equipment additionally incorporates a scanning exposure mechanism (see) by which the reconstructing laser beam is scanned in a raster pattern over the hologram surface in order that the intensity of the regenerated pattern has very high uniformity over the substrate surface and also so that the image can be accurately printed in focus onto a substrate surface onto substrates that are not ideally flat. This is important because high-resolution images have a limited depth of focus and those reconstructed from TIR holograms are only accurately in focus at a distance from the hologram corresponding to the separation between holographic layer and mask during recording.

On the holographic exposure equipment accurate focussing of the image onto the substrate surface is obtained by an optical sub-system that continuously measures the local separation between the hologram and substrate surfaces at the position of the illumination beam as it scans the hologram, and by using actuators to continuously adjust the position of the substrate so that the local separation corresponds to the required value.

The lithographic equipment further integrates an alignment system to allow “higher-level” patterns recorded in TIR holograms to be accurately aligned with respect to “lower-level” patterns previously printed onto the substrate surface. This is important for fabricating the complex structure of micro-circuits constructed of materials with different electrical characteristics which require a number of lithographic steps and post-exposure processes for their formation. For this purpose the lithographic system is provided with two or more alignment microscopes that image onto CCD detectors sets of alignment marks included alongside the circuit patterns in the hologram and on the substrate surfaces, and image processing software that calculates the relative positions of the respective hologram and substrate alignment marks. Actuators in the substrate positioning system then displace the substrate to accurately align, both translationally and rotationally, the circuit pattern on the substrate with that recorded in the hologram, following which the higher-level pattern is printed onto the lower-level pattern.

In addition some models of the equipment possess a substrate positioning system that allows the pattern recorded in the hologram to be printed a number of times onto the substrate surface using a “step-and-repeat” exposure sequence, for example, a pattern of dimensions 120 mm×120 mm recorded in the hologram may be printed 12 times onto a substrate of dimensions 400 mm×500 mm. In this case the substrate positioning mechanics integrate large-travel, x- and y-axis translation stages for stepping the substrate between exposures.

Further, the equipment is commonly provided with automated substrate changing capability so that substrates can be automatically loaded from an input cassette onto the substrate positioning stage for the alignment and exposure sequence and then automatically unloaded from it and transferred into an output cassette.

The various substrate positioning, exposure, focussing, alignment and substrate changing sub-systems on the equipment are linked to a central control system governed by software with a graphical user interface allowing the machine operator to command either individual machine operations or, if desired, a completely automatic exposure of a number of substrates in an input cassette.

A disadvantage of the present lithographic equipment based on TIR holography is that whereas a batch of substrates can be automatically printed with a pattern without operator intervention, if a change of pattern is required in order to print another device level or another device, then the hologram needs to be changed on the prism. This requires a sequence of manual operations from the operator, including unloading the prism and hologram mask from the machine, removing the hologram mask from the prism, cleaning the fluid from the prism and hologram substrate, dispensing new fluid onto the prism surface, mounting and securing the new hologram mask to the prism, and finally loading the prism with the hologram mask back onto the machine. Although feasible, this procedure is undesirable for lithographic equipment used in production mode in, for example, a Class 10 clean-room environment where speed, reliability and the minimisation of dust particles are paramount.

An object of the present invention is thus to overcome the above-described limitation of currently available lithographic systems based on TIR holography; specifically it provides a method and apparatus for automatically changing the hologram mask employed for printing a pattern of features on the lithographic equipment for another hologram mask.

According to a first aspect of the present invention there is provided a method for automatically printing a pattern of features from any of a plurality of hologram masks on a lithographic machine, which method includes:
a) arranging each of the plurality of hologram masks on a first face of each of a plurality of prisms such that the pattern of features recorded in each hologram mask can be reconstructed by an exposure beam illuminating a second face of each of the plurality of prisms;
b) providing an exposure position on the lithographic machine at which any of the plurality of prisms and its respective hologram masks can be arranged such that the pattern recorded in said hologram mask can be printed by an exposure beam illuminating the second face of said prism;
c) providing a prism storage and transport system on the lithographic machine with a plurality of storage positions at which each of the prisms and their respective hologram masks not being used for printing a pattern of features at the exposure position can be arranged and for transporting any of the prisms and their respective hologram masks between any of the exposure position and plurality of storage positions;
d) providing a control system for the prism transport and storage system.

It is further preferable that at least one of the storage positions on the machine is arranged such that any of the plurality of prisms and their respective hologram masks can be readily loaded onto or unloaded from the machine either by a manual operation or by an external robot.

In order to facilitate the storage and transport of the plurality of prisms and their hologram masks it is advantageous that each of the prisms is provided with mechanical parts to form a prism assembly onto which the prism storage and transport system can interconnect, or engage, and that the prism storage and transport system is provided with corresponding elements. For example, each of the prisms may be mounted in a mechanical frame equipped with a handle and the prism storage and transport system equipped with a hook designed so that it can engage the handle of each of the prism assemblies.

Further, it is preferable that each of the prism and hologram mask assemblies is provided with additional mechanical parts so that each prism and hologram mask can be accurately and reproducibly positioned at the exposure position, and that the exposure position have receptor elements corresponding to those parts. The arrangement of such parts might correspond to a design commonly known as a kinematic mount. This is important in order that the exposure beam is able to accurately reconstruct the pattern recorded in the hologram mask.

Further, with respect to the prism storage and transport system, it may comprise a transport system with a single displaceable arm, or robot, for interconnecting, or engaging, any of the plurality of prisms and their respective hologram masks and a plurality of fixed storage positions on the machine, or alternatively it may comprise two or more displaceable arms for interconnecting, or engaging, any of the plurality of prisms and their respective hologram masks such that those prisms and their hologram masks not located at the exposure position may either be attached to a displaceable arm or located at a fixed storage position.

According to a second aspect of the present invention there is provided an apparatus for automatically printing a pattern of features from any of a plurality of hologram masks on a lithographic machine, which apparatus includes:
a) a plurality of prisms onto the first face of each of which can be arranged each of the plurality of hologram masks such that the pattern of features recorded in each hologram mask can be reconstructed by an exposure beam illuminating a second face of each of the plurality of prisms;
b) an exposure position on the lithographic machine at which any of the plurality of prisms and their respective hologram masks can be arranged such that the pattern recorded in said holographic mask can be printed by an exposure beam illuminating the second face of said prism;
c) a prism storage and transport system on the lithographic machine with a plurality of storage of positions at which each of the prisms and their respective hologram masks not being used for printing a pattern of features at the exposure position can be arranged and for transporting any of the prisms and their respective hologram masks between any of the exposure position and plurality of storage positions;
d) a control system for the prism transport and storage system.

Preferred embodiments of the invention will now be described in detail by way of example and with reference to the accompanying drawings in which

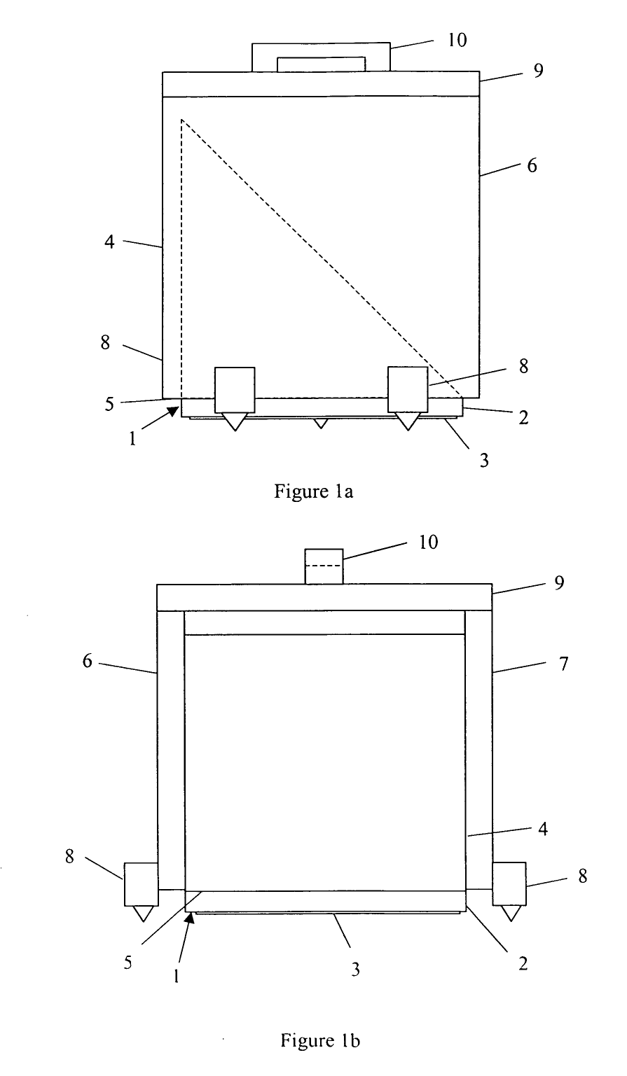

FIG. 1 shows a prism and hologram mask in a mechanical frame.

FIG. 2 shows a TIR holographic lithographic system with an integrated system for automatically reconstruction of patterns recorded in any of 3 hologram masks.

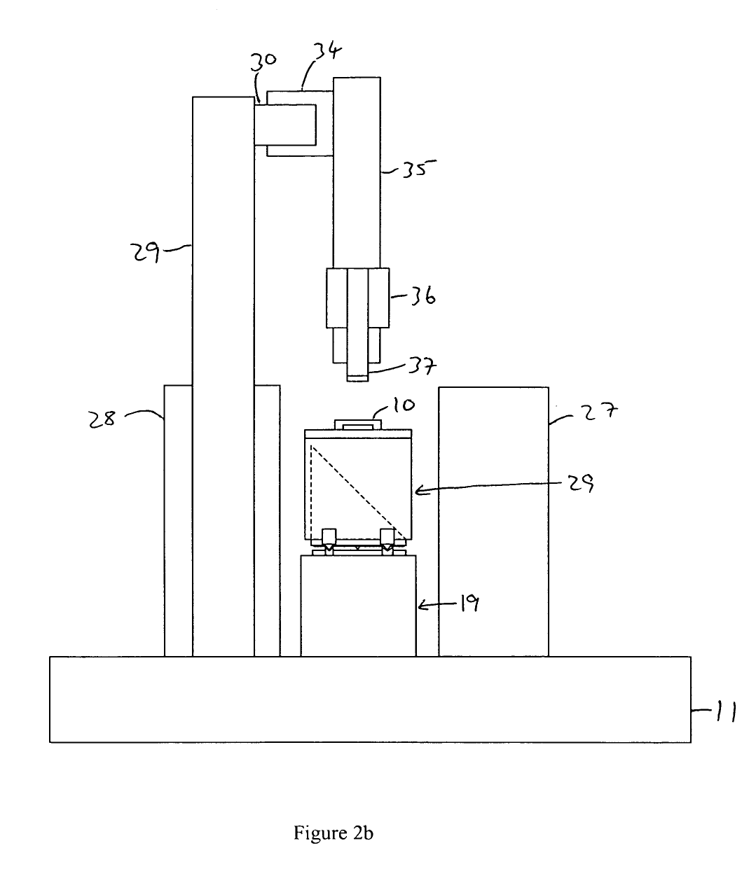

FIG. 3 shows an alternative embodiment, for automatically reconstructing the patterns recorded in any of 4 hologram masks.

With reference first to FIG. 1 in which FIGS. 1a and 1b show respectively a side view and front view of the prism assembly, each hologram mask 1 consisting of a 7′ square glass plate 2 with the hologram recorded in a layer of photopolymer 3 on its lower surface is mounted to the bottom surface of a 45°, 45°, 90° glass prism 4 with a layer of low-volatility fluid 5 between the two having the same refractive index as the glass plate 2 and the prism 4. Onto the two triangular surfaces of the prism are glued rectangular metallic side-plates 6,7 onto which are affixed three feet 8 on their outside surfaces, two on one side-plate 6 and one on the other side-plate 7, for supporting the prism 4 and hologram mask 1 at its different positions in the machine. Affixed to the top edges of the side-plates and connecting the two is a top-plate 9 to rigidify the prism assembly and above that is affixed a handle 10 for enabling the prism transport system to interconnect, or engage the prism assembly in order to transport it around the machine.

FIGS. 2 illustrates a preferred embodiment of the invention in which FIGS. 2a and 2b show respectively front and side views of a hologram mask changing system mounted to a supporting table of a lithographic machine 11. On the machine there are three prism and hologram mask assemblies 12, 13, 14 of the type described in FIG. 1. The first of these 12 is shown at a first of three prism storage 15 position at the extreme left side of the machine. Each of the three position storage positions 15, 16, 17 comprise a raised pedestal 19 on whose surface are three receptor elements 20 for accommodating the three feet 8 of the prism assemblies. The first prism storage position 15 may also be used for manual loading of the prism assemblies onto the machine and also for unloading them. An external robot (not shown in the diagram) might also be used for loading and unloading the prism. The second prism assembly 13 is located at the exposure position 22 on the machine. Below the prism assembly 13 at the exposure position 22 is a photoresist coated substrate 24 to be printed on the surface of a vacuum chuck 25 which is mounted to a high-accuracy substrate positioning system 26. In front of the prism assembly 13 is situated a first scanning system 27 for scanning a UV exposure beam in a raster pattern through the hypotenuse face of the prism in order to print the pattern recorded in the hologram mask onto the substrate 21. Behind the prism assembly is the second scanning system 28 for scanning a beam from a focus measurement module through the vertical face of the prism in order to measure the distance between the hologram mask and the substrate 24.

Constructed around and above the prism and hologram mask assemblies is the prism and hologram mask transport system 29, comprising a gantry formed of a horizontal beam 30 incorporating a first rail affixed to two vertical supports 31, 32 at the left and right sides of the machine along which a prism transport robot 33 can travel. The prism transport robot 33 comprises a first sliding part 34, whose displacement along the beam horizontal 30 is effected by a motor via a spindle and other standard mechanical parts disposed within or around the beam 30 which are well known to mechanical engineers and so are unnecessary to describe here and are omitted from the diagram. Below the sliding part 34 is mounted a vertical column 35 incorporating a second rail along which a second sliding part 36 can travel. The displacement of this second sliding part 36 is again effected by a motor via a spindle and other standard mechanical parts that are unnecessary to describe in further detail here. This second sliding part 36 has an end-effector 37 designed such that it can hook under the handle 10 of each prism and hologram mask assembly. The third prism assembly 14 is shown attached to the end-effector 37. The prism transport robot 33 without a prism assembly attached to its end-effector is shown by dashed lines 40.

Transfer of any of the prism and hologram mask assemblies 12, 13, 14 from any of the prism storage and exposure positions 15, 16, 17, 22 to any other of the same positions is illustrated firstly by FIG. 3 in which the first sliding part 34 is displaced above and slightly to the left of the particular prism assembly concerned after which the second sliding part 36 lowers until the end-effector 37 is at the level of the handle 10 of the prism assembly. The first sliding part 34 again displaces until the end-effector 37 engages the handle 10. Displacing the second sliding part 36 upwards then results in the prism assembly being raised above the other prism assemblies on the machine. Next the first sliding part 34 displaces the prism assembly such that it is above the storage or exposure positions 15, 16, 17, 22 to receive it; the second sliding part 36 then lowers the prism assembly down onto the storage or exposure position, after which the first sliding part 34 displaces until the end-effector 37 disengages from the handle 10 of the prism assembly, after which the second sliding part 34 raises the end-effector 37 clear of the prism assembly.

The configuration of the prism storage and exposure positions 15, 16, 17, 22 shown in FIG. 2 allows up to 3 prism and hologram mask assemblies to be automatically interchanged at the exposure position 22.

Automatic hologram changing and its integration with the other machine functionalities, including the exposure and focus operations, is provided by a control system with the necessary software and graphical-interface screens for user-friendly operation. For this are also provided proximity detectors at each of the load/unload, exposure, storage positions as well as on the end-effector itself in order that the control system has verification of their status regarding prism occupancy/vacancy.

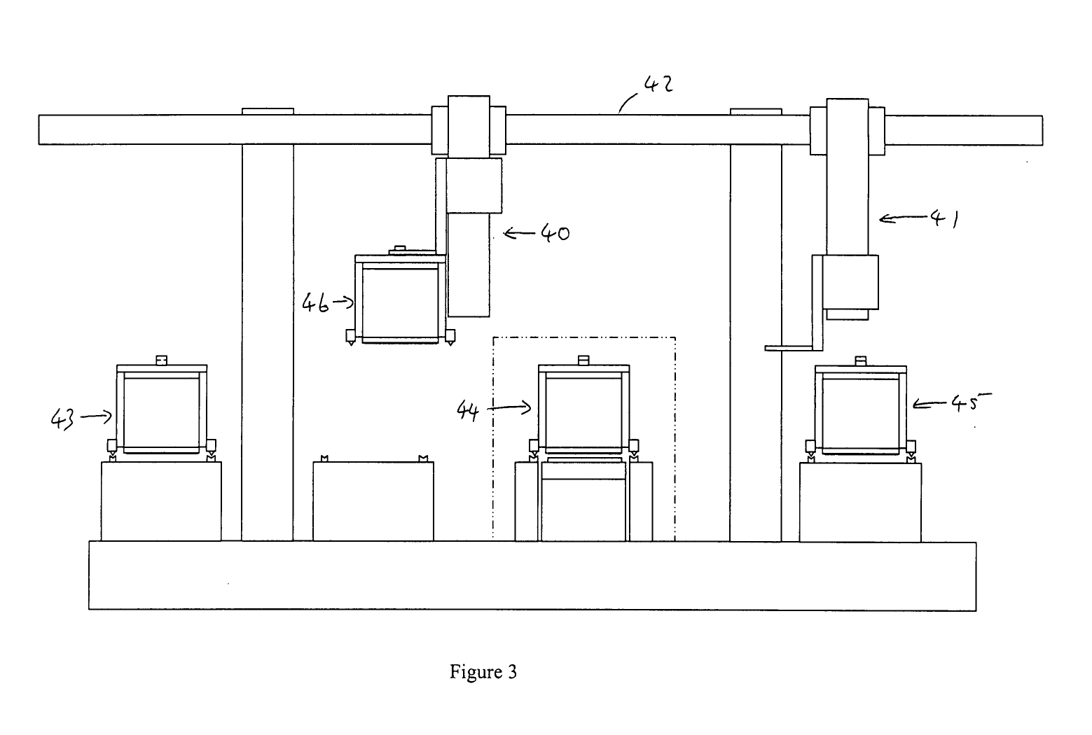

FIG. 4 shows an alternative embodiment of the system which is similar to that shown in FIG. 2 except that there are 2 prism transport robots 40, 41 that can travel along a longer horizontal beam 42. This configuration allows four hologram masks 43, 44, 45, 46 to be loaded onto the machine and interchanged at the exposure position.

1. A method for automatically printing a pattern of features from any of a plurality of hologram masks on a lithographic machine, which method includes:
a) arranging each of the plurality of hologram masks on a first face of each of a plurality of prisms such that the pattern of features recorded in each hologram mask can be reconstructed by an exposure beam illuminating a second face of each of the plurality of prisms;
b) providing an exposure position on the lithographic machine at which any of the plurality of prisms and its respective hologram masks can be arranged such that the pattern recorded in said hologram mask can be printed by an exposure beam illuminating the second face of said prism;
c) providing a prism storage and transport system on the lithographic machine with a plurality of storage positions at which each of the prisms and their respective hologram masks not at the exposure position for reconstructing a pattern of features can be arranged and for transporting any of the prisms and their respective hologram masks between any of the exposure position and plurality of storage positions;
d) providing a control system for the prism transport and storage system.

2. A method according to claim 1 in which at least one of the plurality of storage positions is arranged such that each of the plurality of prisms with their hologram masks arranged thereon can be readily loaded onto or unloaded from the lithographic machine.

3. A method according to claim 2 in which the each of the plurality of prisms and their respective hologram masks can be loaded onto or unloaded from the machine either manually or by an external robot.

4. A method according to claim 1 in which each of the plurality of prisms is additionally provided with a mechanical assembly including parts onto which the prism storage and transport system can interconnect, or engage, and the prism storage and transport system is provided with corresponding mechanical parts.

5. A method according to claim 1 in which the prism storage and transport system comprises a single displaceable arm for interconnecting, or engaging, any of the plurality of prisms and their respective hologram masks and a plurality of fixed storage positions.

6. A method according to claim 1 in which the prism storage and transport system comprises two or more displaceable arms each of which can interconnect, or engage, transport and keep in a storage position any of the plurality of prisms and their respective hologram masks and either no or a number of fixed storage positions.

7. A method according to claim 4 in which the mechanical assembly for each of the plurality of prisms is additionally provided with parts that enable each of the prisms and their respective hologram masks to be accurately and reproducibly located at the exposure position.

8. A method according to claim 1 in which the exposure position and prism storage and transport system are provided with sensors in order that the control system has automatic verification of the status, regarding prism occupancy/vacancy, of the exposure position and prism and transport system.

9. An apparatus for automatically printing a pattern of features from any of a plurality of hologram masks on a lithographic machine, which apparatus includes:
a) a plurality of prisms onto the first face of each of which can be arranged each of the plurality of hologram masks such that the pattern of features recorded in each hologram mask can be reconstructed by an exposure beam illuminating a second face of each of the plurality of prisms;
b) an exposure position on the lithographic machine at which any of the plurality of prisms and their respective hologram masks can be arranged such that the pattern recorded in said hologram mask can be printed by an exposure beam illuminating the second face of said prism;
c) a prism storage and transport system on the lithographic machine with a plurality of storage positions at which each of the prisms and their respective hologram masks not located at the exposure position for reconstructing a pattern of features can be arranged and for transporting any of the prisms and their respective hologram masks between any of the exposure position and plurality of storage positions;
d) a control system for the prism transport and storage system.

10. An apparatus according to claim 9 in which at least one of the plurality of storage positions is arranged such that each of the plurality of prisms and their respective hologram masks can be readily loaded onto or unloaded from the lithographic machine.

11. An apparatus according to claim 9 in which each of the plurality of prisms has mounted to it mechanical means onto which the prism storage and transport system can interconnect, or engage, and the prism storage and transport system is provided with corresponding mechanical parts.

12. An apparatus according to claim 9 in which the prism storage and transport system comprises a single displaceable arm for interconnecting, or engaging, transporting and storing any of the plurality of prisms and their respective hologram masks and a plurality of fixed storage positions.

13. An apparatus according to claim 9 in which the prism storage and transport system comprises two or more displaceable arms each of which can interconnect, or engage, transport and keep in a storage position any of the plurality of prisms and their respective hologram masks and either no or a number of fixed storage positions.

14. An apparatus according to claim 11 in which the mechanical means mounted to each of the plurality of prisms includes parts that enable each of the prisms and their respective hologram masks to be accurately and reproducibly located at the exposure position.

15. An apparatus according to claim 9 in which the exposure position and prism storage and transport system have sensors so that the control system has automatic verification of the status, regarding prism occupancy/vacancy, of the exposure position and prism storage and transport system.
